(19) United States
(12) Patent Application Publication
(10) Pub. No.: US 2009/0106773 A1
(43) Pub. Date: Apr. 23, 2009

(54) Method and system for user-friendly forwarding entry management based on inter-process communication

(75) Inventors: Won-kyoung Lee, Daejeon-si (KR); Jae-woo Park, Daejeon-si (KR); Young-sik Chung, Daejeon-si (KR); Bheom-soon Joo, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Electronics and Telecommunications Research Institute

(21) Appl. No.: 12/157,524

(22) Filed: Jun. 11, 2008

(30) Foreign Application Priority Data
Oct. 23, 2007 (KR) 10-2007-0106702

(51) Int. Cl. G06F 9/46

(52) U.S. Cl. 719/313

(57) ABSTRACT

A method and system for user-friendly forwarding entry management based on inter-process communication (IPC) is provided. The system includes a function input unit inputting a command for forwarding entry management; and an automated process unit verifying parameters included in the function to create a user table, extracting information for creating a forwarding entry management table from the user table, and outputting a forwarding entry management message including the extracted information. The method includes inputting a command for forwarding entry management; verifying parameters included in the command; creating a user table using the parameters if the verification is successful; extracting information for creating a forwarding entry management table from the user table; and outputting a forwarding entry management message including the extracted information.

### CROSS REFERENCE TO RELATED APPLICATIONS

This application claims priority from Korean Patent Application No. 10-2007-0106702, filed on Oct. 23, 2007, the disclosure of which is incorporated herein in its entirety by reference.

### BACKGROUND OF THE INVENTION

1. Field of the Invention

The present invention relates to a method and system for user-friendly forwarding entry management and based on inter-process communication (IPC), more particularly, to a forwarding entry management technology for operating an intermediate node, such as a router or a switch, which forwards packets on a network.

This work was supported by the IT R&D program of Ministry of Information and Communication (MIC)/Institute for Information Technology Advancement (IITA) [2005-S-102-03. Carrier class Ethernet technology].

2. Description of the Related Art

Communication equipment, such as a switch or a router, typically acts as an intermediate node which transmits packets on a network. Forwarding entry management, such as setup, addition, deletion or modification of forwarding entry is required so that the switch or router transmits packets accurately

A user operates communication equipment, such as a switch or a router, through a console using a user interface, such as command-line interface (CLI) or an interface developed by the user. The user interface is configured to receive commands, execute programs, and report results.

Since a typical inter-process communication (IPC) generally calls and uses functions which are offered by Network Processing Forum (NPF) Application Programming Interface (API), users have to input commands using parameters which comply with NPF API.

The typical IPC includes parameters which users do not need to set or are difficult to fully comprehend. Therefore, the users have difficulty in operating the communication equipment, such as a switch or a router.

Additionally, in order to manage a forwarding entry, a core component (CC) requires a plurality of tables related to the forwarding entry management. Accordingly, a user has to set each table and has to call API according to the order in which each table is created.

Accordingly, it is not easy to operate the communication equipment, such as the switch or router, causing inefficient network management. Additionally, a user can only recognize input of an incorrect parameter after the user's command is transmitted down to a line card and the user then receives callback data of ‘fail’ from the line card. Furthermore, since a single command is executed through many steps, it is difficult to find causes of errors.

### SUMMARY OF THE INVENTION

The present invention provides a method and system for efficiently managing IPC-based user-friendly forwarding entry for operating an intermediate node, such as a router or a switch, which transmits packets on a network, by inputting a CLI command only once.

Additional aspects of the invention will be set forth in the description which follows, and in part will be apparent from the description, or may be learned by practice of the invention.

The present invention discloses an inter-process communication (IPC)-based user-friendly forwarding entry management system including: a management information storage unit inputting user information for forwarding entry management; and an automated process unit verifying the user information to create a user table, extracting information for creating a forwarding entry management table from the user table, and outputting a forwarding entry management message including the extracted information.

The present invention also discloses an inter-process communication (IPC)-based user-friendly forwarding entry management method including: inputting user information for forwarding entry management; verifying the user information; creating a user table using the parameters if the verification is successful; extracting information for creating a forwarding entry management table from the user table; and outputting a forwarding entry management message including the extracted information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a flow chart of a typical operation of a bridge.

FIG. 2 is a schematic diagram of data plane for forwarding entry management.

FIG. 3 illustrates a forwarding entry management table.

FIG. 4 is a block diagram of a user-friendly forwarding entry management system based on inter-process communication (IPC) according to an exemplary embodiment of the present invention.

FIG. 5 is a flow chart of a parameter verification procedure.

FIG. 6 illustrates a procedure for creating a forwarding entry management table.

FIG. 7 is a flow chart of a forwarding entry management procedure of an IPC-based user-friendly forwarding entry management system according to an exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art.

Communication equipment, such as repeaters, hubs, bridges, switches and routers, operate in different layers in Open Systems Interconnection (OSI) seven layer model. The layers are important since information for path decision uses different data for each communication equipment.

The repeaters and the hubs work in a physical layer, the bridges and the switches work in a data link layer, and the routers work in a network layer.

For a switch or a router to accurately transmit packets, appropriate forwarding entry management, such as forwarding entry setup, addition, deletion or modification, needs to be performed by a bridge.

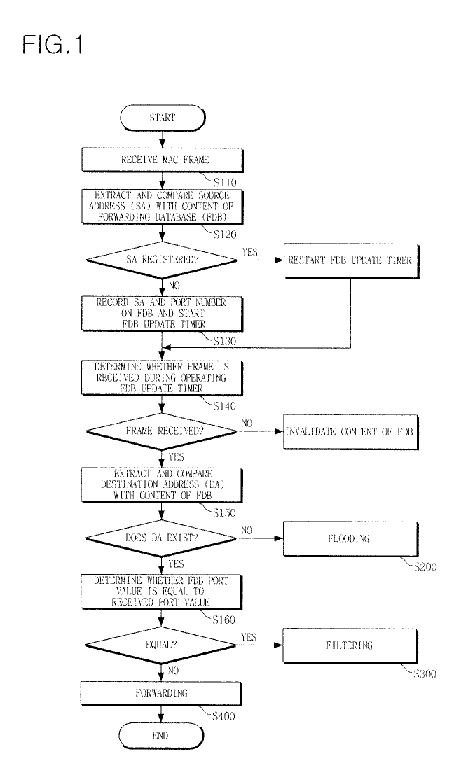

FIG. 1 is a flow chart of a typical operation of a bridge. The bridge receives and processes all frames, which are input to a port, regardless of their destination addresses (DA). In operation S110, a MAC frame is received. In operation S120, a source address (SA) is extracted and is compared with content of a forwarding database (FDB).

If the FDB does not include the SA, the SA and a received port number are recorded on the FDB and a forwarding database update timer (FDB_update timer) is activated in operation S130. If the FDB includes the SA, the FDB_update timer is restarted.

In operation S140, it is determined whether a frame is received from the same transmitting station during activating the FDB_update timer. If the frame is not received, content of the FDB is invalidated. This function is referred to as dynamic MAC learning which considers terminal mobility.

If the frame is received, DA of the following frame is extracted and is compared with content of the FDB in operation S150.

If the FDB does not include the DA, the received frame is transmitted to all ports except the received port in operation S200. This is referred to as flooding.

If the FDB includes the DA, it is determined in operation S160 whether a port value of the FDB is equal to a value of the received port. If the port value of the FDB is equal to the value of the received port, it is determined as local traffic and the received frame is dropped in operation S300. This is referred to as filtering.

If the port value of the FDB is not equal to the value of the received port, the frame is transmitted to the port recorded on the FDB in operation S400. This is referred to as forwarding.

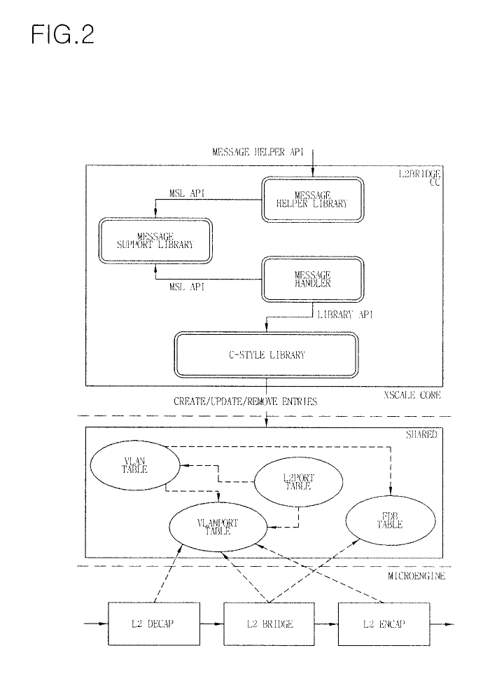

FIG. 2 is a schematic diagram of forwarding entry management using Network Processor (NP) of Intel Corporation. The NP includes a microengine, which processes packets, and an Xscale core, which sets the microengine and creates and manages a plurality of tables related to L2 function.

FIG. 2 illustrates L2 bridge core component (CC), which is included in the Xscale core, and L2 microblock, which is included in the microengine. A message helper library provides Message Helper API, which is needed to operate an L2 bridge function, and forwards messages received from upper levels to the core component (CC) using a message support library.

A message handler performs message parsing of a received message, converts it to corresponding library API, and reports the result to a control plane using the message support library.

An L2 packet, which is received into an L2 decap microblock, is forwarded to a desired destination port through the L2 decap microblock, an L2 bridge microblock, and an L2 encap microblock. At this time, the destination port is found by searching VLAN, L2 port, VLAN port and FDB tables, which are created by the L2 bridge core component.

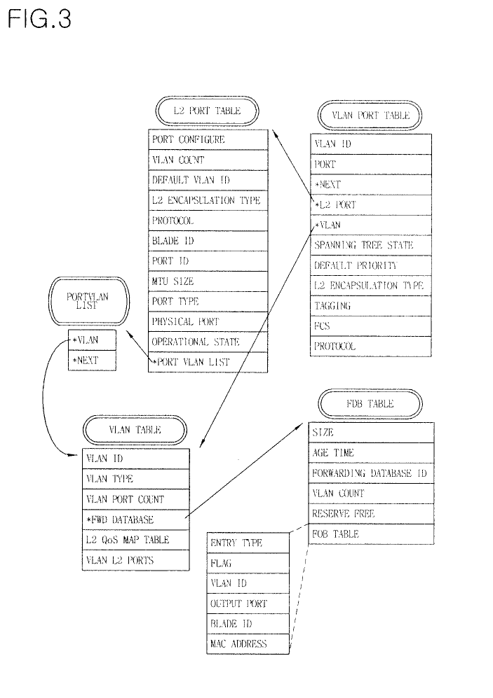

FIG. 3 illustrates the type, structure and connection of the tables which are shared by the L2 bridge CC and the L2 microblock. The VLAN port table includes an L2 port field, which stores an address of a corresponding L2 port table, and a VLAN field, which stores an address of a corresponding VLAN table. A port VLAN list field of the L2 port table indicated by the VLAN port table stores an address of a corresponding VLAN table.

A Fwd database field of the VLAN table indicated by the VLAN port table stores an address of a corresponding FDB table. Accordingly, an output port of an incoming MAC frame is founded by searching the VLAN table using VLAN ID of the frame and searching FDB entry using a hash key based on the MAC address in the FDB table indicated by the VLAN table.

As shown in FIG. 3, since the VLAN table, L2 port table, VLAN port table, and FDB table are associated with one another, a user has to configure the forwarding entry management table according to the order.

In the typical IPC, a user inputs parameters which comply with the NPF API through a command-line interface (CLI), and transmits information down to a forwarding plane through a control plane platform development kit (CP-PDK).

For example, in order to add a forwarding entry having a single MAC address, two L2 port tables for a sending port and a destination port have to be first created and a VLAN table has to be created next. Additionally, two VLAN port tables have to be created to make the created L2 ports belong to a corresponding VLAN. A FDB table is finally created.

When a user sets this procedure on his/her own, the user needs to input the following functions and parameters, which may be obtained using API functions defined in NPF API:

1) API function for creating L2 port table handle
for example, L2_PortTableHandle_Create ‘Handle Number’;

2) API function for creating L2 port table
for example, L2Port_Create ‘Blade ID, Port Number, Port Type, Default VLAN ID, Protocol’;

3) API function for creating VLAN table handle
for example, L2_VLANTableHandle_Create ‘Handle Number’;

4) API function for creating VLAN table
for example, L2_VLAN_Create ‘VLAN ID, VLAN Type’;

5) API function for creating VLAN port table
for example, L2_VLANPort_Add ‘VLAN ID, Blade ID, Port Number, Tagging, Protocol, Encapsulation’;

6) API function for creating forwarding database (FDB) table handle
for example, L2_MACTableHandle_Create ‘Handle Number’;

7) API function for creating FDB table
for example, L2UC_MACEntry_Add ‘MAC Address, VLAN ID, Blade ID, Port Number, Entry Type, Flag’.

Accordingly, when the user sets on his/her own for forwarding entry management, the user has to know beforehand the order of tables created in the L2 bridge CC and parameters of API. Accordingly, it is difficult for general users other than program developers to configure and manage a network using a switch.

To address this problem, the following configuration is proposed in which a user inputs a command only once to manage a forwarding entry.

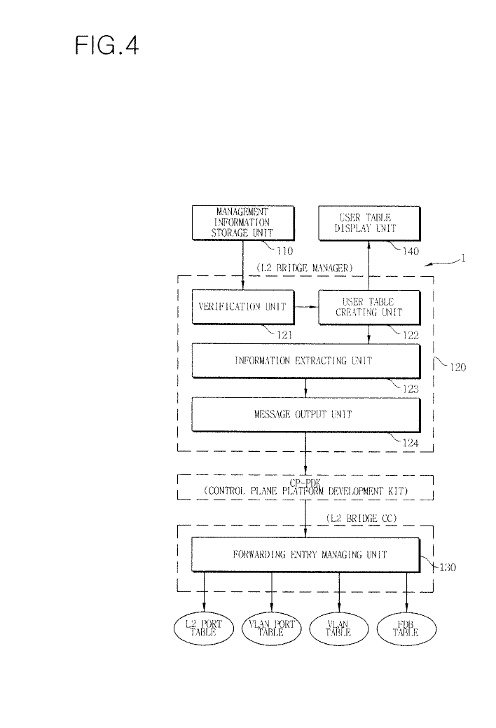

FIG. 4 is a block diagram of a user-friendly forwarding entry management system based on inter-process communication (IPC) according to an exemplary embodiment of the present invention.

The IPC-based user-friendly forwarding entry management system is configured in software or hardware for forwarding entry management, such as setup, addition, deletion or modification of forwarding entry, of a bridge which performs the above-mentioned operation.

The IPC-based user-friendly forwarding entry management system 100 is configured to efficiently manage forwarding entry for operating an intermediate node, such as a router or a switch, which transmits packets on a network, by inputting a command only once. The IPC-based user-friendly forwarding entry management system 100 includes a management information storage unit 110 and an automated process unit 120.

The management information storage unit 110 receives a command for forwarding entry management. The management information storage unit 110 may be a command-line interface (CLI) for inputting a command for forwarding entry management.

The command input by the management information storage unit 110 is to set, add, delete or modify the forwarding entry. The function includes parameters for forwarding entry management. The parameters may include destination MAC address, VLAN ID, destination port number, default VLAN ID, tagging flag, blade number, and flooding flag.

The destination MAC address indicates a destination address of a frame; the VLAN ID, a virtual LAN identifier; the destination port number, number of a port where a frame is to be transmitted; the tagging flag, a flag determining whether a VLAN tag is attached to a frame when the frame is transmitted; the blade number, number of a line card where a frame is transmitted; and the flooding flag, a flag determining whether flooding is applied, the flooding indicating a received frame is transmitted to all ports except a received port when a destination address (DA) does not exist in a forwarding database (FDB).

The automated process unit 120 verifies parameters included in a function input through the management information storage unit 110 to create a user table, extracts information required for creating a forwarding entry management table from the user table, and outputs a forwarding entry management message containing the extracted information. In FIG. 4, an L2 bridge manager indicates the automated process unit 120.

The automated process unit 120 includes a verification unit 121, a user table creating unit 122, an information extracting unit 123, and a message output unit 124. The verification unit 121 parses parameters included in a function input through the management information storage unit 110.

The verification unit 121 verifies the parameters about whether there is MAC address of a destination, whether VLAN ID needs to be replaced with default VLAN ID, whether destination port number has a value within an appropriate range, whether blade number has a value within an appropriate range, and whether flooding occurs.

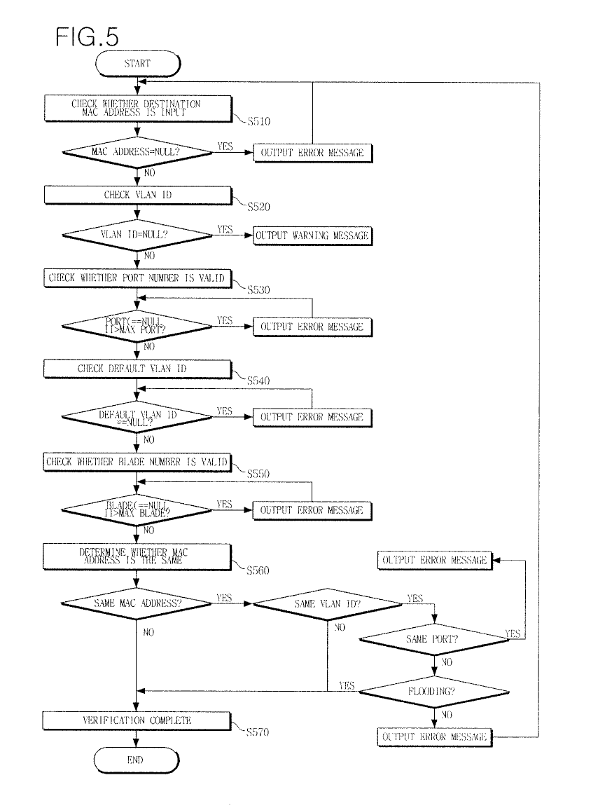

FIG. 5 is a flow chart of a parameter verification procedure of a verification unit 121.

In operation S510, it is determined whether MAC address of a destination where a frame is to be transmitted is input. If the MAC address is not input, an error message is output. If the MAC address is input, VLAN ID is verified in operation S520.

If the VLAN ID is not input, a warning message indicating that it is replaced with default VLAN ID is output. If the VLAN ID is input, it is verified in operation S530 whether a port number is valid.

If the port number does not exist or exceeds a maximum number, an error message is output. If the port number exists, the default VLAN ID is verified in operation S540. If the default VLAN ID does not exist, an error message is output. If the default VLAN ID exists, it is verified in operation S550 whether a blade number is valid.

If the blade number does not exist or exceeds a maximum number, an error message is output. If the blade number exists, it is verified in operation S560 whether MAC address is equal to the MAC address which is input in the preceding operation. If not equal, the parameter verification process ends in operation S570.

If the MAC address is the same, it is verified whether the VLAN ID is the same. If the VLAN ID is not the same, the parameter verification process ends in operation S570. If the VLAN ID is the same, it is verified whether the port number is the same.

If the port number is the same, an error message indicating that a forwarding entry is already created is output. If not the same, it is verified whether flooding occurs. If it is determined that flooding occurs, the parameter verification process ends in operation S570. If not, an error message indicating that the input parameter needs to be verified is output. As such, the parameter verification process is completed.

After the parameter verification process of the verification unit 121, the user table creating unit 122 creates a user table using the parameters.

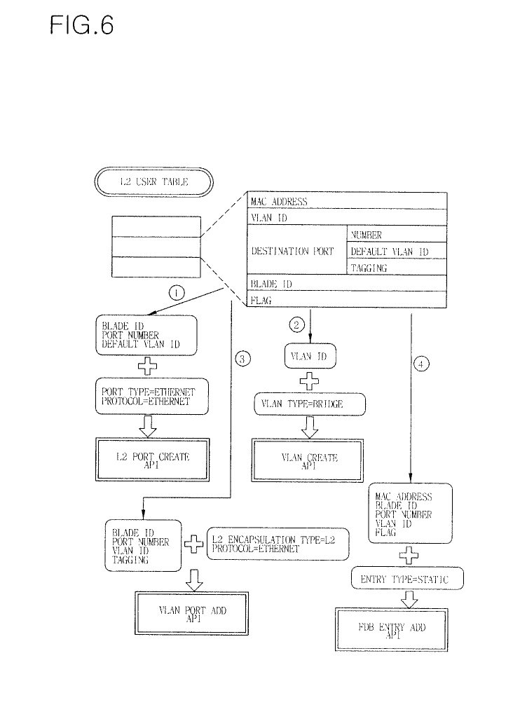

FIG. 6 illustrates a user table which is created by the user table creating unit 122.

The user table includes MAC address of a destination, VLAN ID, destination port number, default VLAN ID, tagging flag, blade number, and flooding flag, which are the parameters of the function input by the management information storage unit 110. From the user table, other tables are further created for forwarding entry management.

The information extracting unit 123 extracts information required for creating a forwarding entry management table from the user table created by the user table creating unit 122. The forwarding entry management table includes an L2 port table for port mapping, a VLAN table for setting a virtual LAN (VLAN), a VLAN port table for mapping between the L2 port table and the VLAN table, and a forwarding database (FDB) table for path setting.

As shown in FIG. 6, the information extracting unit 123 extracts blade number, destination port number, and default VLAN ID from the user table to create the L2 port table. The message output unit 124 outputs the extracted information which further includes information about port type and protocol. The L2 port table is created by a forwarding entry managing unit 130.

The information extracting unit 123 extracts VLAN ID from the user table to create the VLAN table. The message output unit 124 outputs the extracted information which further includes information about VLAN type. The VLAN table is created by the forwarding entry managing unit 130.

To create the VLAN port table, the information extracting unit 123 extracts blade number, destination port number, VLAN ID, and tagging flag from the user table. The message output unit 124 outputs the extracted information which further includes information about L2 encapsulation type and protocol. The VLAN port table is created by the forwarding entry managing unit 130.

To create the FDB table, the information extracting unit 123 extracts destination MAC address, blade number, destination port number, VLAN ID, and flooding flag from the user table. The message output unit 124 outputs the extracted information which further includes information about entry type. The FDB table is created by the forwarding entry managing unit 130.

The message output unit 124 outputs the forwarding entry management message including the information extracted by the information extracting unit 123. The forwarding entry management message may be a message for setting, adding, deleting or modifying the forwarding entry.

The forwarding entry management message is transmitted to the forwarding entry managing unit 130 through a control plane platform development kit (CP-PDK). The forwarding entry managing unit 130 performs forwarding entry management, such as setting, adding, deleting or modifying of the forwarding entry.

Accordingly, a user can efficiently manage a forwarding entry for the operation of an intermediate node, such as a router or a switch, transmitting packets on a network by inputting a command only once to set, add, delete or modify the forwarding entry. Therefore, the user can conveniently operate communication equipment, such as a router or a switch, and can quickly address problems related to the forwarding entry management.

The IPC-based user-friendly forwarding entry management system 100 may further include a forwarding entry managing unit 130.

The forwarding entry managing unit 130 creates a forwarding entry management table with reference to the forwarding entry management message output from the automated process unit 120, and manages a forwarding entry using the forwarding entry management table. In FIG. 4, the L2 bridge core component indicates the forwarding entry managing unit 130.

The forwarding entry management message is a message for setting, adding, deleting or modifying the forwarding entry. As described above, the forwarding entry management table includes an L2 port table for port mapping, a VLAN table for setting a virtual LAN (VLAN), a VLAN port table for mapping between the L2 port table and the VLAN table, and a forwarding database (FDB) table for path setting.

Accordingly, the forwarding entry managing unit 130 creates a forwarding entry management table for setting, adding, deleting or modifying the forwarding entry according to the forwarding entry management message.

The forwarding entry management unit 130 sequentially creates the L2 port table, the VLAN table, the VLAN port table and the FDB table. The four tables have to be sequentially created since they are associated with one another.

The automated process unit 120 may further include a user table display unit 140. The user table display unit 140 displays the user table created by the user table creating unit 122 so that a user may verify parameters, such as destination MAC address, VLAN ID, destination port number, default VLAN ID, tagging flag, blade number and flooding flag, of a command input through the management information storage unit 110.

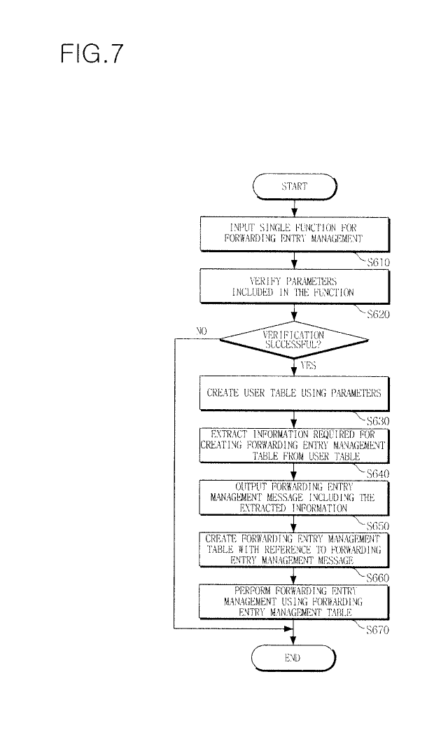

FIG. 7 is a flow chart of a forwarding entry management procedure of an IPC-based user-friendly forwarding entry management system according to an exemplary embodiment of the invention.

In operation S610, the IPC-based user-friendly forwarding entry management system 100 provides a user interface to allow a user to input a command for forwarding entry management, such as addition, deletion or modification of forwarding entry, through the function input unit 110.

In operation S620, the IPC-based user-friendly forwarding entry management system 100 verifies parameters contained in the command input through the verification unit 121 of the automated process unit 120.

After successful verification, in operation S630, the IPC-based user-friendly forwarding entry management system 100 creates a user table using the parameters through the user table creating unit 122 of the automated process unit 120.

In operation S640, the IPC-based user-friendly forwarding entry management system 100 extracts information required for creating a forwarding entry management table from the user table through the information extracting unit 123 of the automated process unit 120.

In operation S650, the IPC-based user-friendly forwarding entry management system 100 outputs a forwarding entry management message including the extracted information through the message output unit 124 of the automated process unit 120.

In operation S660, the IPC-based user-friendly forwarding entry management system 100 creates the forwarding entry management table through the forwarding entry managing unit 130 with reference to the forwarding entry management message.

The forwarding entry management table includes an L2 port table for port mapping, a VLAN table for setting a virtual LAN (VLAN), a VLAN port table for mapping between the L2 port table and the VLAN table, and a forwarding database (FDB) table for path setting.

In operation S670, the IPC-based user-friendly forwarding entry management system 100 performs forwarding entry management, such as setting, adding, deleting or modifying of forward entry, through the forwarding entry managing unit 130 using the forwarding entry management table.

Accordingly, a user can efficiently manage a forwarding entry for the operation of an intermediate node, such as a router or a switch, transmitting packets on a network by inputting a command only once to set, add, delete or modify the forwarding entry. Therefore, the user can conveniently operate communication equipment, such as a router or a switch, and can quickly address problems related to the forwarding entry management.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A user-friendly forwarding entry management system based on inter-process communication (IPC), comprising:
a management information storage unit inputting a command for forwarding entry management; and
an automated process unit verifying parameters included in the command to create a user table, extracting information for creating a forwarding entry management table from the user table, and outputting a forwarding entry management message including the extracted information.

2. The user-friendly forwarding entry management system of claim 1, wherein the automated process unit comprises:
a verification unit parsing and verifying the parameters included in the function;
a user table creating unit creating a user table using the parameters if the verification is successful;
an information extracting unit extracting information for creating a forwarding entry management table from the user table; and
a message output unit outputting a forwarding entry management message including the extracted information.

3. The user-friendly forwarding entry management system of claim 2, further comprising a forwarding entry managing unit creating a forwarding entry management table with reference to the forwarding entry management message and performing forwarding entry management using the forwarding entry management table.

4. The user-friendly forwarding entry management system of claim 2, wherein the automated process unit further comprises a user table display unit displaying the user table.

5. The user-friendly forwarding entry management system of claim 1, wherein the forwarding entry management table comprises:
an L2 port table for port mapping;
a virtual local area network (VLAN) table for VLAN setting;
a VLAN port table for mapping between the L2 port table and the VLAN table; and
a forwarding database (FDB) table for path setting.

6. The user-friendly forwarding entry management system of claim 5, wherein the forwarding entry managing unit creates the L2 port table, the VLAN table, the VLAN port table, and the FDB table in order of precedence.

7. The user-friendly forwarding entry management system of claim 1, wherein the function is to set, add, delete or modify a forwarding entry.

8. The user-friendly forwarding entry management system of claim 7, wherein the forwarding entry management message is a message for setting, adding, deleting or modifying a forwarding entry.

9. The user-friendly forwarding entry management system of claim 2, wherein the parameters comprises MAC address of a destination, VLAN ID, destination port number, default VLAN ID, tagging flag, blade number, and flooding flag.

10. The user-friendly forwarding entry management system of claim 9, wherein the verification unit verifies the parameters by checking whether there is MAC address of a destination, whether VLAN ID is to be replaced with default VLAN ID, whether destination port number has a value within an appropriate range, whether blade number has a value within an appropriate range, and whether flooding occurs.

11. A user-friendly forwarding entry management method based on inter-process communication (IPC), comprising:
inputting a function for forwarding entry management;
verifying parameters included in the function;
creating a user table using the parameters if the verification is successful;
extracting information for creating a forwarding entry management table from the user table; and
outputting a forwarding entry management message including the extracted information.

12. The user-friendly forwarding entry management method of claim 11, further comprising:
creating a forwarding entry management table with reference to the forwarding entry management message; and
performing forwarding entry management using the forwarding entry management table.
